(19) United States
(12) Patent Application Publication
(10) Pub. No.: US 2022/0033557 A1
(43) Pub. Date: Feb. 3, 2022

(54) PHOTOPOLYMERIZATION METHOD FOR PREPARING BLOCK COPOLYMER WITH MAIN-CHAIN SEMI-FLUORINATED ALTERNATING COPOLYMER

(71) Applicant: SOOCHOW UNIVERSITY, Suzhou (CN)

(72) Inventors: Zhenping CHENG, Suzhou (CN); Jiannan CHENG, Suzhou (CN); Lifen ZHANG, Suzhou (CN); Kai TU, Suzhou (CN); Jinying WANG, Suzhou (CN); Xiulin ZHU, Suzhou (CN)

(21) Appl. No.: 16/965,716

(22) PCT Filed: Jul. 3, 2019
(86) PCT No.: PCT/CN2019/094540

§ 371 Date: Jul. 29, 2020

(30) Foreign Application Priority Data
Jun. 28, 2019 (CN) 201910579630.1

(51) Int. Cl. C08F 293/00; C08F 2/50; C08F 4/80; C08K 5/1535; C08F 220/30; C08F 220/34; C08F 220/32; C08F 220/14; C08G 61/04

(52) U.S. Cl. CPC C08F 293/005; C08F 2/50; C08F 4/80; C08K 5/1535; C08F 220/305; C08G 2261/146; C08F 220/325; C08F 220/14; C08G 61/04; C08G 2261/124; C08G 2261/1642; C08F 220/34

(57) ABSTRACT

The present invention relates to a photopolymerization method for preparing a block polymer with a main-chain “semi-fluorinated” alternating copolymer, which comprises the following steps: under a protective atmosphere, subjecting a methacrylate monomer and a “semi-fluorinated” alternating copolymer (AB)ₙ macroinitiator to light-controlled living radical polymerization in an organic solvent at 20-30° C. in the presence of a photocatalyst, where the polymerization reaction is continued for at least half an hour under irradiation of light at 390-590 nm, to obtain a block copolymer of a main-chain polyolefin, polyester, or polyether “semi-fluorinated” alternating copolymer. The polymerization method is carried out under irradiation of visible light, the polymerization process has the characteristics of “living” radical polymerization, and the molecular weight distribution of the prepared polymer is narrow.

### FIELD OF THE INVENTION

The present invention relates to the technical field of preparation of polymers, and more particularly to a photopolymerization method for preparing a block copolymer with a main-chain “semi-fluorinated” alternating copolymer.

### DESCRIPTION OF THE RELATED ART

The presence of polymers with topological structures not only widens the performance of polymer materials, but also makes the correlation between the polymer structure and the performance more obvious, while such a correlation is great significance for designing high polymer materials. The regulation of polymer topology is an important research direction in polymer synthesis chemistry. Common polymer topologies include linear, star-like, comb-like, cyclic, hyperbranched and dendritic structures, etc., and are reported in numerous related literatures. Moreover, from the point of view of the chemical structure of the polymer chain, the performance of the polymer is closely related to its chain structure. The fluoropolymers have been playing a very important role in the application of polymers. This can be attributed to their notable corrosion, aging and heat resistance, low surface energy, and other properties. The main reason is that the fluorine atom has not only the characteristics of low polarizability and strong electronegativity, but also small atomic radius and strong C—F bond energy. Therefore, the fluoropolymers are widely used in antifouling coatings, hydrophobic materials, surfactants, and other areas.

According to the different positions of fluorine-containing segments, the fluoropolymers can be divided into side-chain fluoropolymers and main-chain fluoropolymers. The synthesis of side-chain fluoropolymer comprises directly introducing a fluoromonomer (such as pentafluorostyrene, and fluorinated (meth)acrylate, etc.), and allowing it to undergo “living”/controlled radical polymerization such as atom transfer radical polymerization (ATRP) and reversible addition-fragmentation chain transfer (RAFT) to obtain a side-chain type fluoropolymer. The main-chain fluoropolymer is mainly obtained by iodine transfer polymerization (ITP) of a gaseous fluoromonomer (such as vinylidene fluoride (VDF), etc.). Generally speaking, due to the limitations of the types of monomers, the currently available fluoropolymers suffer from fewer varieties and less structural designability, and thus have difficulty to meet the requirements of materials for diverse polymer structures. The present inventors have recently developed a novel step transfer-addition & radical-termination (START) polymerization method by visible light-induced catalytic polymerization of α,ω-diiodoperfluoroalkane (monomer A) and α,ω-non-conjugated diene (monomer B). Through the structural design of the non-conjugated diene monomer B, novel “semi-fluorinated” alternating copolymers (AB)ₙ with diverse polymer structures and adjustable molecular weight can be obtained (note: because the monomer A in this type of alternating copolymers is a perfluorocarbon segment, such copolymers are called “semi-fluorinated” alternating copolymers in order to distinguish them from other types of fluoropolymers, where n represents the degree of polymerization). This opens up a new train of thought and provides a feasible polymerization method for solving the above-mentioned existing problem of fewer varieties of fluoropolymers. To make full use of the excellent properties of fluoropolymers, new fluoropolymers of various topologies are synthesized with such unique novel “semi-fluorinated” alternating copolymer (AB)ₙ as the building blocks, which can not only open up a new research direction, but also promote to further enrich the types of fluoropolymers and broaden their scope of application.

### SUMMARY OF THE INVENTION

To solve the above technical problems, an object of the present invention is to provide a photopolymerization method for preparing a block copolymer with a main-chain “semi-fluorinated” alternating copolymer. The polymerization method is carried out under irradiation of visible light, the polymerization process has the characteristics of “living” radical polymerization, and the molecular weight distribution of the prepared polymer is narrow.

A first object of the present invention is to provide a photopolymerization method for preparing a block copolymer with a main-chain “semi-fluorinated” alternating copolymer, which comprises the following steps:

under a protective atmosphere, subjecting a methacrylate monomer and a “semi-fluorinated” alternating copolymer (AB)ₙ macroinitiator to light-controlled living radical polymerization in an organic solvent at 20-30° C. in the presence of a photocatalyst, where the polymerization reaction is continued for at least half an hour under irradiation of light at 390-590 nm, to obtain a block copolymer of the main-chain “semi-fluorinated” alternating copolymer, where

when the “semi-fluorinated” alternating copolymer(AB)ₙ macroinitiator has a structure of Formula (1), the resulting block copolymer of the main-chain “semi-fluorinated” alternating copolymer has a structure of Formula (2); and

when the “semi-fluorinated” alternating copolymer(AB)ₙ macroinitiator has a structure of Formula (3), the resulting block copolymer of the main-chain “semi-fluorinated” alternating copolymer has a structure of Formula (4);

in which Formulas (1)-(4) are shown below:

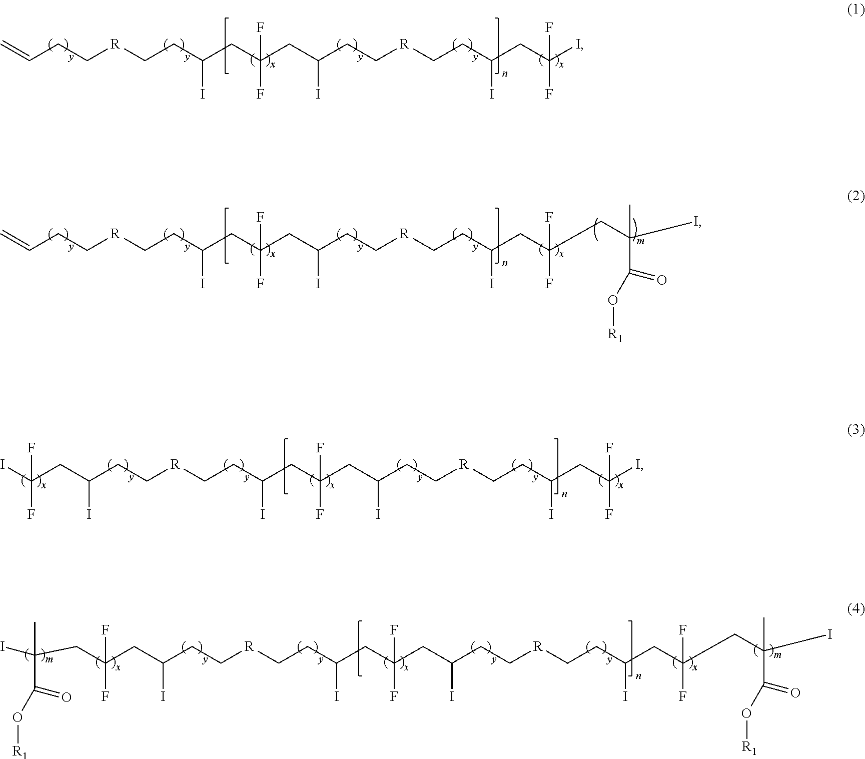

where x=4-8, y=0-3, n=4-30, and m=100-500;

R is selected from a C₁-C₆ alkyl group, an aryl ether group or an acyloxy group;

R₁ is selected from a C₁-C₆ alkyl group, a polyethylene glycol group, a C₁-C₆ alkyl group substituted with amino, or a C₁-C₆ alkyl group substituted with epoxy.

Preferably R is selected from methyl, 1,4-phenylene ether group, adipoyloxy or terephthaloyloxy;

Preferably R₁ is selected from methyl, n-butyl, n-hexyl, polyethylene glycol monomethyl ether group, dimethylaminoethyl or glycidyl.

Preferably x=4, 6 or 8; y=0 or 1; n=4-15; and m=200-500.

In an embodiment, the methacrylate monomer is methyl methacrylate, butyl methacrylate, hexyl methacrylate, glycidyl methacrylate, N,N-dimethylaminoethyl methacrylate, or polyethylene glycol monomethyl ether methacrylate.

In an embodiment, the “semi-fluorinated” alternating copolymer (AB)ₙ macroinitiator is obtained by START polymerization of a monomer A with a monomer B. The monomer A is selected from 1,4-diiodoperfluorobutane, 1,6-diiodoperfluorohexane or 1,8-diiodoperfluorooctane; and the monomer B is selected from 1,7-octadiene, 1,9-decadiene, 1,4-phenylene diallyl ether, 1,4-phenylenebis(1-hexenyl) ether, diallyladipate, diallyl terephthalate or bis(1-hexenyl) terephthalate.

In an embodiment, the “semi-fluorinated” alternating copolymer (AB)ₙ macroinitiator is prepared by a method as disclosed in CN107619466A.

In an embodiment, the molar ratio of the monomer A to the monomer B is 1-1.2:1. When the molar ratio of the monomer A to the monomer B is 1:1, the “semi-fluorinated” alternating copolymer(AB)ₙ macroinitiator of Formula (1) is obtained; and when the molar ratio of the monomer A to the monomer B is 1.2:1, the “semi-fluorinated” alternating copolymer (AB)ₙ macroinitiator of Formula (3) is obtained.

The “semi-fluorinated” alternating copolymer macroinitiator used in the present invention is designated as (AB)ₙ. Specifically, the “semi-fluorinated” alternating copolymers obtained by polymerizing 1,6-diiodoperfluorohexane as the monomer A and 1,7-octadiene as the monomer B are respectively designated as (AB₁)ₙ and (AB₁)ₙA; the “semi-fluorinated” alternating copolymer obtained by polymerizing 1,6-diiodoperfluorohexane as the monomer A and 1,4-phenylene bis(1-hexenyl)ether as the monomer B is designated as (AB₂)ₙ; and the “semi-fluorinated” alternating copolymer obtained by polymerizing 1,6-diiodoperfluorohexane as the monomer A and bis(1-hexenyl) terephthalate as the monomer B is designated as (AB₃)ₙ. The structural formulas of the above “semi-fluorinated” alternating copolymers are shown below:

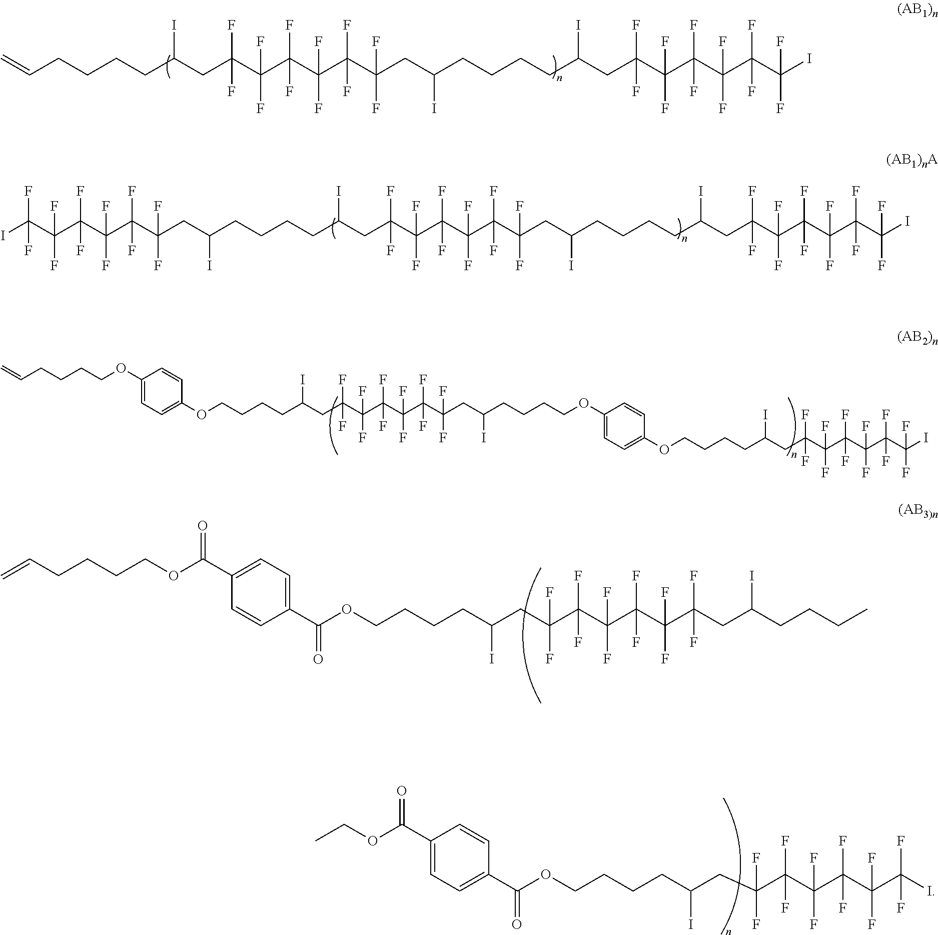

The calculation method of the degree of polymerization (n) of the “semi-fluorinated” alternating copolymer (AB)ₙ can be illustrated by taking (AB₁)ₙ as an example. The structure of (AB₁)ₙ is characterized by ¹H NMR to obtain the chemical shifts of hydrogen atoms (H) at different positions in the polymer. The integral product of chemical shift c (CH₂═CH—) is 1.00, the integral sum of chemical shifts a,b(CH₂═CH—) is 1.83, and the integral product of chemical shift h (—CH(I)CH₂CF₂₋) is 16.31. By analyzing the chemical structural formula of the polymer, h=2n−1, n=(h+1)/2, so the degree of polymerization of the polymer is n≈8-9.

Preferably, the “semi-fluorinated” alternating copolymer (AB)ₙ has a polydispersity index of 1.40-1.90.

Preferably, the photocatalyst is tris(2,2′-bipyridine)ruthenium dichloride (Ru(bpy)₃Cl₂) and sodium ascorbate.

Preferably, the concentration of the methacrylate monomer in the organic solvent is 0.002 mol/mL-0.1 mol/mL.

Preferably, the molar ratio of the methacrylate monomer, the “semi-fluorinated” alternating copolymer (AB)ₙ macroinitiator, tris(2,2′-bipyridine)ruthenium dichloride (Ru(bpy)₃Cl₂), and sodium ascorbate (AsAc—Na) is 30-500:1-3:0.1-0.5:1-5, and preferably 200-500:1-2:0.1-0.2:1-2.

Preferably, the organic solvent is acetone, tetrahydrofuran, or N,N-dimethylformamide, and more preferably acetone.

Preferably, the light of 390-590 nm is emitted by an LED light source. More preferably, the light source is a blue LED lamp.

Preferably, the reaction time is 0.5-30 h. After reaction for 24 h, the conversion rate of DMAEMA monomer can reach 99.5%.

Preferably, the methacrylate monomer is methyl methacrylate (MMA), glycidylmethacrylate (GMA), N,N-dimethylaminoethyl methacrylate (DMAEMA), or polyethylene glycol monomethyl ether methacrylate (PEGMA). The block copolymers of the main-chain “semi-fluorinated” alternating copolymer obtained by polymerization of MMA, GMA, PEGMA, and DMAEMA initiated with (AB₁)ₙ as a macroinitiator are respectively designated as (AB₁)ₙ-b-PMMA, (AB₁)ₙ-b-PGMA, (AB₁)ₙ-A-PPEGMA, and (AB₁)ₙ-b-PDMAEMA. The block copolymers of the main-chain “semi-fluorinated” alternating copolymer obtained by polymerization of MMA initiated respectively with (AB₁)ₙA, (AB₂)ₙ or (AB₃)ₙ as a macroinitiator are respectively designated as PMMA-b-(AB₁)ₙA-b-PMMA, (AB₂)ₙ-b-PMMA, and (AB₃)ₙ-b-PMMA. The structures of the above products are shown below:

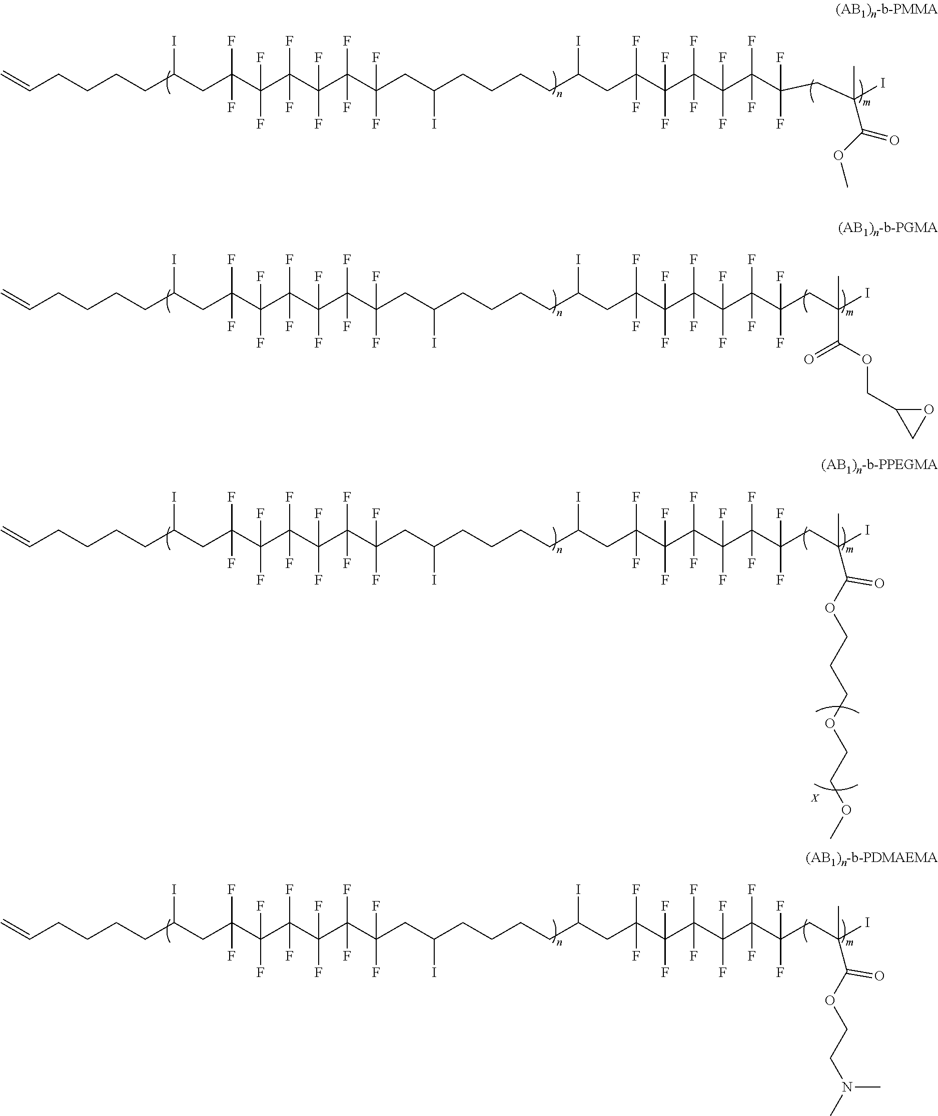

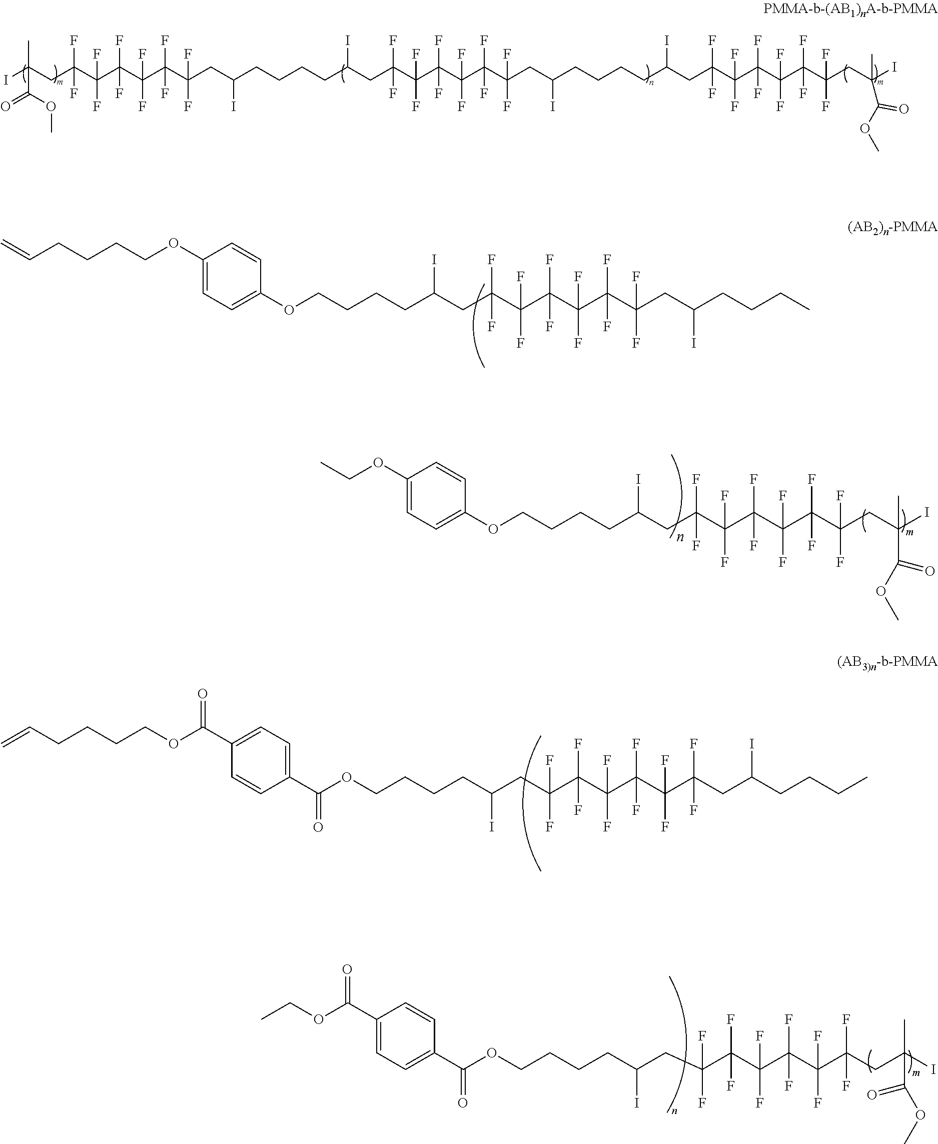

where n=4-30, and m=100-500; and preferably, n=4-15, and m=200-500.

A second object of the present invention is to provide a block copolymer with a main-chain “semi-fluorinated” alternating copolymer of Formula (2) or Formula (4) prepared by the photopolymerization method as described above, which is a block copolymer of a main-chain polyolefin, polyester or poly ether “semi-fluorinated” alternating copolymer.

Preferably, the polydispersity index of the block polymer of the main-chain “semi-fluorinated” alternating copolymer of Formula (2) or Formula (4) is 1.40-1.90.

In the preparation method of the present invention, the reaction principle is as follows. Controlled polymerization of methacrylate monomer is initiated by using a “semi-fluorinated” alternating copolymer(AB)ₙ as a macroinitiator in the presence of a photocatalyst. As the polymerization proceeds, the degree of polymerization(n) of the block copolymer gradually increases. Moreover, by designing the structure of the monomer B in the “semi-fluorinated” alternating copolymer (AB)ₙ, block copolymers of various main-chain polyolefin, polyester or poly ether “semi-fluorinated” alternating copolymers can be prepared.

By means of the above technical solutions, the present invention has the following advantages.

In the present invention, living radical polymerization is induced by an LED lamp at room temperature (20-30° C.), and the operation is simple and safe. By means of the preparation method of the present invention, ln([M]₀/[M]) of the monomer exhibits a first-order linear relationship over time, the molecular weight of the polymer increases linearly with the increase of the conversion rate, and the molecular weight distribution is also narrow, conforming the characteristics of “living” radical polymerization. The structure and molecular weight of the polymer have designability.

The above description is only a summary of the technical solutions of the present invention. To make the technical means of the present invention clearer and implementable in accordance with the disclosure of the specification, the preferred embodiments of the present invention will be described in detail with reference to the accompanying drawings.

### BRIEF DESCRIPTION OF THE DRAWINGS

FIG. 1 is a ¹H NMR spectrum of the main-chain “semi-fluorinated” alternating copolymer (AB₁)ₙ;

FIG. 2 is a ¹⁹F NMR spectrum of the main-chain “semi-fluorinated” alternating copolymer (AB₁)ₙ;

FIG. 3 is a ¹H NMR spectrum of the block copolymer (AB₁)ₙ-b-PMMA of the main-chain “semi-fluorinated” alternating copolymer prepared in Example 1;

FIG. 4 shows a curve of elution by GPC of the block copolymer (AB₁)ₙ-b-PMMA of the main-chain “semi-fluorinated” alternating copolymer obtained at various polymerization times in Example 1;

FIG. 5 shows a first-order kinetic curve of the monomer concentration [M] of the block monomer (AB₁)ₙ-b-PMMA of the “semi-fluorinated” alternating copolymer vs reaction time in Example 1;

FIG. 6 shows a curve of relation between Mₙ, M_{w}/Mₙ and the conversion rate of the block copolymer (AB₁)ₙ-b-PMMA of the “semi-fluorinated” alternating copolymer;

FIG. 7 is a ¹H NMR spectrum of the main-chain “semi-fluorinated” alternating copolymer (AB₁)ₙA in Example 3;

FIG. 8 is a ¹H NMR spectrum of the main-chain “semi-fluorinated” alternating copolymer (AB₂)ₙ in Example 3;

FIG. 9 is a ¹H NMR spectrum of the main-chain “semi-fluorinated” alternating copolymer (AB₃)ₙ in Example 3.

### DESCRIPTION OF THE PREFERRED EMBODIMENTS

The present invention will be further described below by way of examples with reference to the accompanying drawings. The descriptions below are only preferred examples of the present invention, and are not intended to limit the present invention. For those skilled in the art, various modifications and changes can be made to the present invention without departing from the spirit and principle of the present invention, which are all fall within the protection scope of the present invention.

Chemical reagents used in examples of the present invention: methyl methacrylate (95%), purchased from Aladdin; glycidyl methacrylate (>95%), purchased from TCI; 2-(dimethylamino)ethyl methacrylate (>98.5%), purchased from TCI; polyethylene glycol) methyl ether methacrylate (PEGMA, Mₙ=300 g mol⁻¹), purchased from Aldrich; tris (2,2′-bipyridine)ruthenium dichloride (98%), purchased from Energy Chemical Co., Ltd.; sodium ascorbate, purchased from Bellingway Technology Co., Ltd. acetone, AR; tetrahydrofuran, AR; and methanol, industrial grade.

Test equipment: PL gel permeation chromatograph; INOVA 400 MHz Nuclear Magnetic Resonance Spectrometer.

Test conditions: HR1, HR3 and HR4 used in tandem, differential detector, mobile phase tetrahydrofuran (1 mL/min), column temperature 30° C., and correction with a standard prepared with polystyrene or polymethyl methacrylate. ¹H NMR spectrum was obtained on INOVA 300 MHz Nuclear Magnetic Resonance Spectrometer with TMS as internal standard.

### Example 1

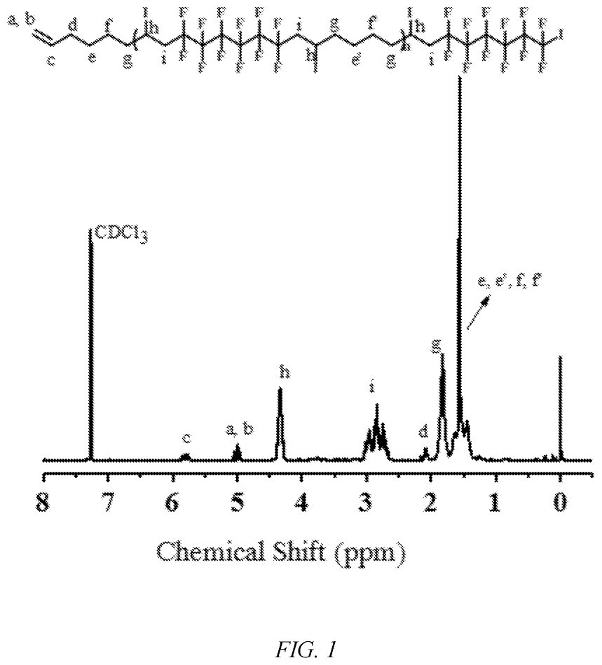

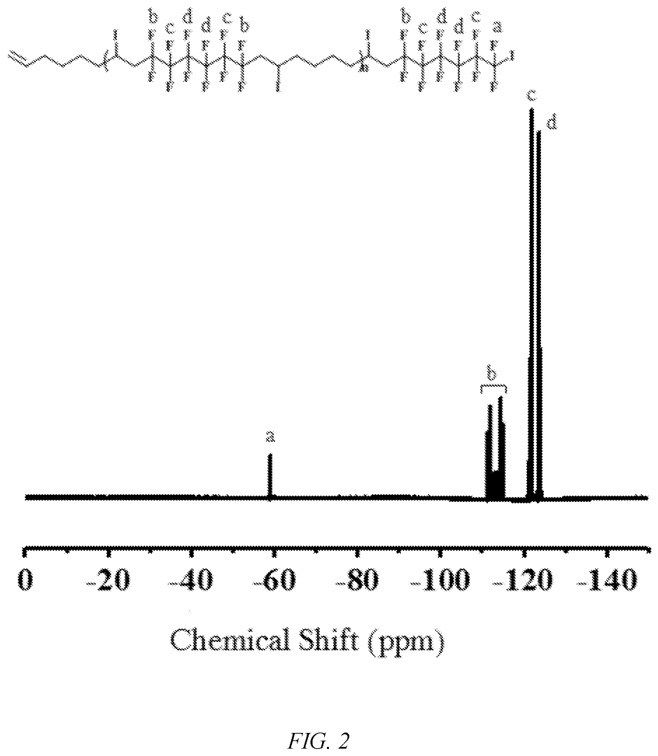

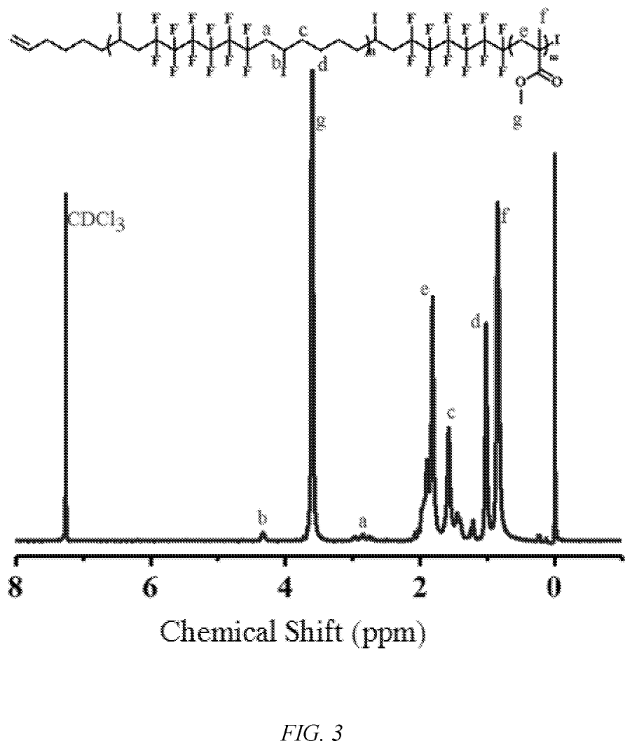

The monomer methyl methacrylate (5 mmol) to be polymerized, the alternating fluoropolymer macroinitiator (AB₁)ₙ (0.01 mmol), the photocatalyst tris (2,2′-bipyridine)ruthenium dichloride (Ru(bpy)₃Cl₂) (0.002 mmol), sodium ascorbate (AsAc—Na) (0.01 mmol), and acetone (0.5 mL) were added to a photoreaction tube, deoxygenated, and polymerized at room temperature under blue LED irradiation at 485 nm. After a predetermined time of reaction, the reaction tube was opened, a small amount of polymer solution was taken for test by ₁H NMR spectroscopy, and the conversion rate of the monomer and the molecular weight (M_{n,NMR}) by ₁H NMR spectroscopy were calculated. The rest of the polymer solution was dissolved in a certain amount of tetrahydrofuran. After passing through a neutral Al₂O₃ column, a precipitating agent was added, and after standing, suction filtering, and drying under vacuum, a block copolymer (AB₁)ₙ-b-PMMA of a “semi-fluorinated” alternating copolymer was obtained. FIGS. 1-2 show the test results by ¹H NMR and ¹⁹F NMR spectroscopy of (AB₁)ₙ respectively. The degree of polymerization is 8-9. FIG. 3 is a ¹H NMR spectrum of the block copolymer (AB₁)ₙ-b-PMMA of the “semi-fluorinated” alternating copolymer.

Multiple sets of parallel experiments were performed following the above steps. The polymerization time was 1, 2, 4, 6, 8 and 10 h respectively. The polymerization results of (AB₁)ₙ-b-PMMA at various times were tested.

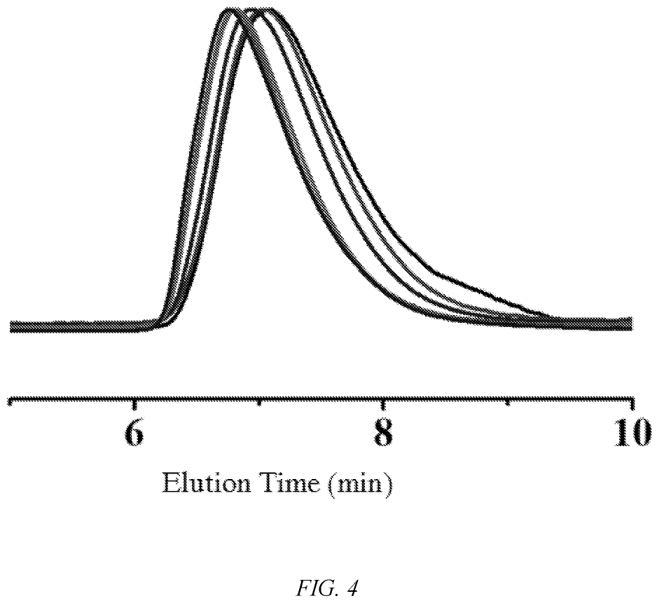

FIG. 4 shows a curve of elution by GPC of (AB₁)ₙ-b-PMMA obtained at various polymerization times. From right to left, the reaction time corresponding to the curve is gradually extended, and the polymerization time is 1, 2, 4, 6, 8, and 10 h, respectively. The molecular weights and polydispersity indices (PDIs) of (AB₁)ₙ-b-PMMA obtained are 21400 g/mol, 1.70; 27800 g/mol, 1.44; 32000 g/mol, 1.37; 37600 g/mol, 1.38; 38100 g/mol, 1.34; 46200 g/mol, 1.55 respectively.

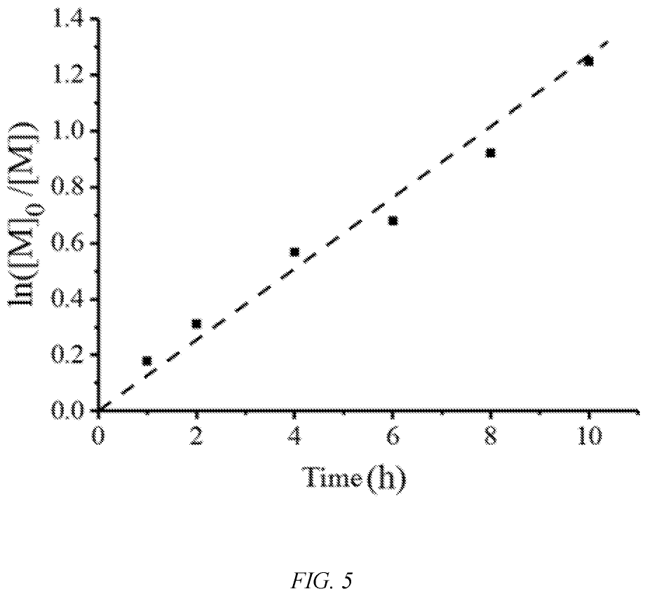

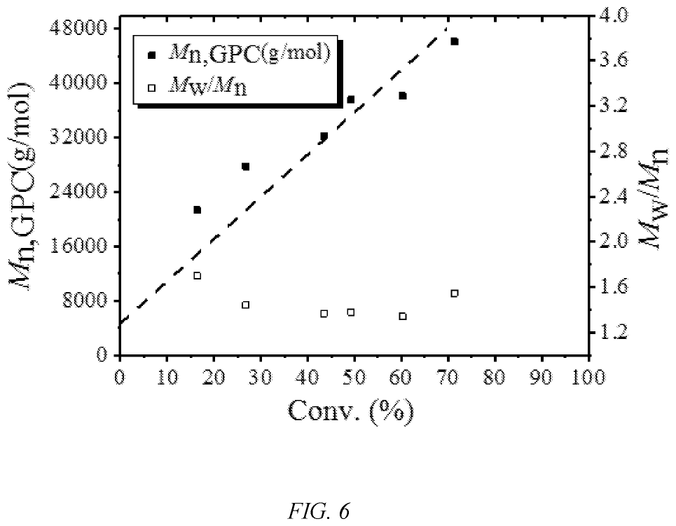

FIGS. 5-6 shows the first-order kinetic curve of the monomer concentration [M] of (AB₁)ₙ-b-PMMA vs reaction time, and the curve of relation between Mₙ and M_{w}/Mₙ and the conversion rate of (AB₁)ₙ-b-PMMA. The results show that the change curves of molecular weight and molecular weight distribution of the polymer indicate that the molecular weight M_{n,GPC} increases linearly with the conversion rate of the monomer, the polymer has good controllability, and the molecular weight distribution is narrow.

### Example 2

Various monomers (5 mmol) to be polymerized, the alternating fluoropolymer macroinitiator (AB₁)ₙ (0.025 mmol), the photocatalyst tris(2,2′-bipyridine)ruthenium dichloride (Ru(bpy)₃Cl₂) (0.005 mmol), sodium ascorbate (AsAc—Na) (0.025 mmol), and acetone (0.5 mL) were added to a photoreaction tube, deoxygenated, and polymerized at room temperature under blue LED irradiation at 485 nm. The molecular weight of (AB₁)ₙ is 4000 g/mol, and PDI is 1.40. After a predetermined time of reaction, the reaction tube was opened, a small amount of polymer solution was taken for test by ¹H NMR spectroscopy, and the conversion rate of the monomer and the molecular weight (M_{n,NMR}) by ¹H NMR spectroscopy were calculated. The rest of the polymer solution was dissolved in a certain amount of tetrahydrofuran. After passing through a neutral Al₂O₃ column, a precipitating agent was added, and after standing, suction filtering, and drying under vacuum, a polymer was obtained. The results are shown in Table 1.

TABLE 1
Polymerization results of various polymerization systems

| | | Time | Conversion | M_{n, th} | M_{n, GPC} | |
|---|---|---|---|---|---|---|
| No. | Monomer | (h) | rate (%) | (g/mol) | (g/mol) | M_{w}/Mₙ |
| 1 | GMA | 24 | 79.9 | 26700 | 34400 | 1.28 |
| 2 | DMAEMA | 24 | 99.5 | 34000 | 39600 | 1.21 |
| 3 | PEGMA-300 | 12 | 37.2 | 28000 | 46600 | 1.55 |
| 4^{a} | PEGMA-300 | 12 | 87.2 | 31900 | 46900 | 1.60 |

In Table 1, the test conditions of No. 4 is [M]₀:[(AB₁)ₙ]₀:[Ru(bpy)₃Cl₂]₀:[AsAc—Na]₀=100:1:0.2:1. In Table 1, PEGMA-300 and PEGMA-400 respectively means that the molecular weight of polyethylene glycol in the polyethylene glycol monomethyl ether methacrylate is 300 g/mol or 400 g/mol.

### Example 3

The monomer methyl methacrylate (5 mmol) to be polymerized, various alternating fluoropolymer macroinitiator (AB₁)ₙA, (AB₂)ₙ or (AB₃)ₙ (0.01 mmol), the photocatalyst tris(2,2′-bipyridine)ruthenium dichloride (Ru(bpy)₃Cl₂) (0.002 mmol), sodium ascorbate (AsAc—Na) (0.01 mmol), and acetone (0.5 mL) were added to a photoreaction tube, deoxygenated, and polymerized at room temperature under blue LED irradiation at 485 nm. The molecular weight and PDI of (AB₁)ₙA, (AB₂)ₙ or (AB₃)ₙ are respectively 6400 g/mol, 1.75; 2200 g/mol, 1.28; and 9800 g/mol, 1.91.

After a predetermined time of reaction, the reaction tube was opened, a small amount of polymer solution was taken for test by ¹H NMR spectroscopy, and the conversion rate of the monomer and the molecular weight (M_{n,NMR}) by ¹H NMR spectroscopy were calculated. The rest of the polymer solution was dissolved in a certain amount of tetrahydrofuran. After passing through a neutral Al₂O₃ column, a precipitating agent was added, and after standing, suction filtering, and drying under vacuum, a polymer was obtained.

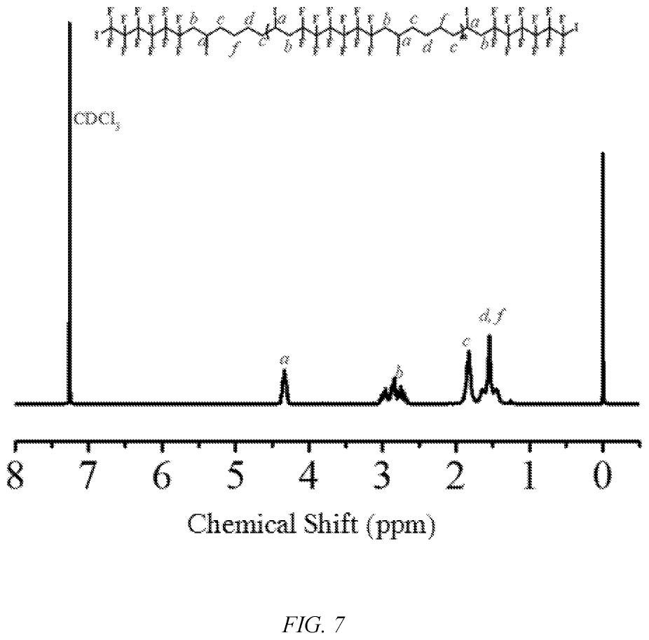

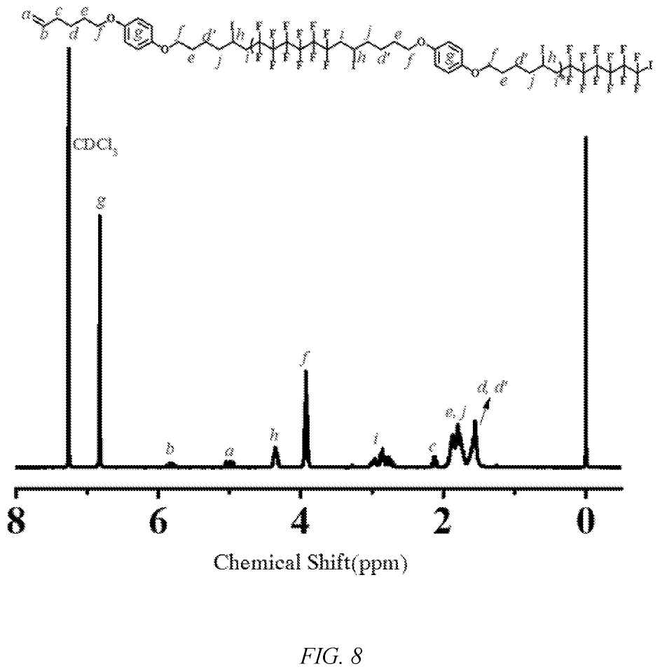

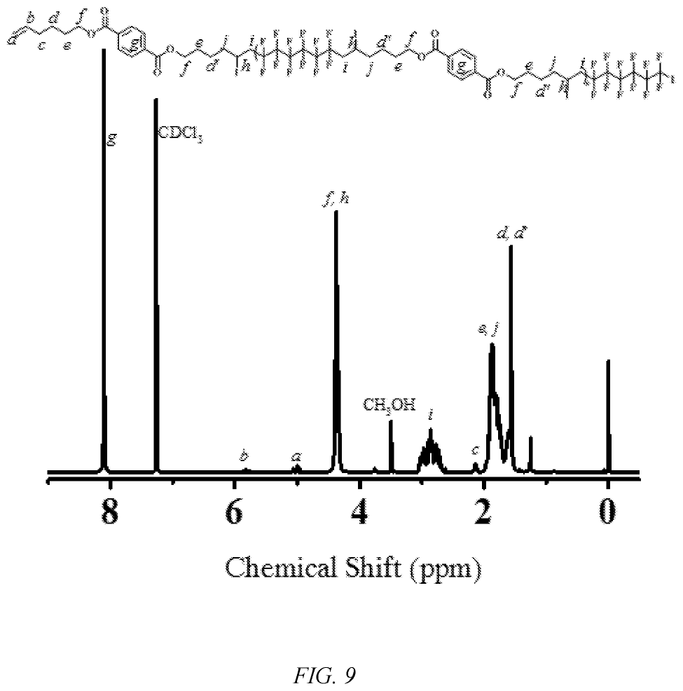

FIGS. 7-9 respectively show the test results by ¹H NMR of the macroinitiator (AB₁)ₙA, (AB₂)ₙ or (AB₃)ₙ in this example.

Table 2 shows the results of polymerization using different macroinitiators. It can be seen that the polymerization of methyl methacrylate monomer is successfully achieved, and the molecular weight distribution of the resulting polymer is narrow.

TABLE 2
Effects of different macroinitiators on the polymerization system

| | | Time | Conversion | M_{n, th} | M_{n, GPC} | |
|---|---|---|---|---|---|---|
| No. | Monomer | (h) | rate (%) | (g/mol) | (g/mol) | M_{w}/Mₙ |
| 1 | (AB₁)ₙA | 5.5 | 32.5 | 22700 | 32300 | 1.34 |
| 2 | (AB₂)ₙ | 11 | 33.3 | 18900 | 50900 | 1.43 |
| 3 | (AB₃)ₙ | 10 | 45.2 | 32400 | 25200 | 1.99 |

In Table 2, [MMA]₀:[(AB)ₙ]₀:[Ru(bpy)₃Cl₂]₀:[AsAc—Na]₀=500:1:0.2:1.

The above description is only preferred embodiments of the present invention and not intended to limit the present invention, it should be noted that those of ordinary skill in the art can further make various modifications and variations without departing from the technical principles of the present invention, and these modifications and variations also should be considered to be within the scope of protection of the present invention.

1. A photopolymerization method for preparing a block copolymer with a main-chain “semi-fluorinated” alternating copolymer, comprising steps of:
under a protective atmosphere, subjecting a methacrylate monomer and a “semi-fluorinated” alternating copolymer (AB)ₙ macroinitiator to light-controlled living radical polymerization in an organic solvent at 20-30° C. in the presence of a photocatalyst, where the polymerization is continued for at least half an hour under irradiation of light at 390-590 nm, to obtain a block copolymer of the main-chain “semi-fluorinated” alternating copolymer, wherein
when the “semi-fluorinated” alternating copolymer(AB)ₙ macroinitiator has a structure of Formula (1), the resulting block copolymer of the main-chain “semi-fluorinated” alternating copolymer has a structure of Formula (2); and
when the “semi-fluorinated” alternating copolymer(AB)ₙ macroinitiator has a structure of Formula (3), the resulting block copolymer of the main-chain “semi-fluorinated” alternating copolymer has a structure of Formula (4),
in which Formulas (1)-(4) are shown below: 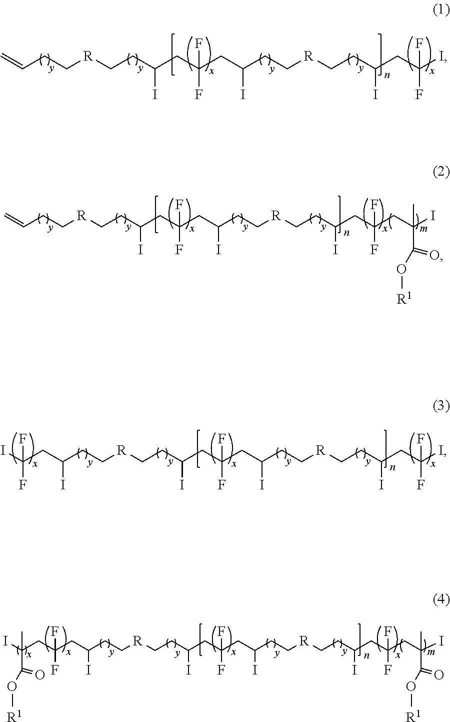
where x=4-8, y=0-3, n=4-30, and m=100-500;
R is selected from a C₁-C₆ alkyl group, an aryl ether group or an acyloxy group; and
R₁ is selected from a C₁-C₆ alkyl group, a polyethylene glycol group, a C₁-C₆ alkyl group substituted with amino, or a C₁-C₆ alkyl group substituted with epoxy.

2. The photopolymerization method according to claim 1, wherein the methacrylate monomer is methyl methacrylate, butyl methacrylate, hexyl methacrylate, glycidyl methacrylate, N,N-dimethylaminoethyl methacrylate, or polyethylene glycol monomethyl ether methacrylate.

3. The photopolymerization method according to claim 1, wherein the “semi-fluorinated” alternating copolymer(AB)ₙ macroinitiator is obtained by START polymerization of a monomer A with a monomer B, wherein the monomer A is selected from 1,4-diiodoperfluorobutane, 1,6-diiodoperfluorohexane or 1,8-diiodoperfluorooctane; and the monomer B is selected from 1,7-octadiene, 1,9-decadiene, 1,4-phenylene diallyl ether, 1,4-phenylene bis(1-hexenyl) ether, diallyladipate, diallyl terephthalate or bis(1-hexenyl) terephthalate.

4. The photopolymerization method according to claim 1, wherein the molar ratio of the monomer A to the monomer B is 1-1.2:1.

5. The photopolymerization method according to claim 1, wherein x=4, 6, or 8.

6. The photopolymerization method according to claim 1, wherein y=0 or 1.

7. The photopolymerization method according to claim 1, wherein the photocatalyst is tris(2,2′-bipyridine)ruthenium dichloride and sodium ascorbate.

8. The photopolymerization method according to claim 1, wherein the concentration of the methacrylate monomer in the organic solvent is 0.002 mol/mL-0.1 mol/mL.

9. The photopolymerization method according to claim 1, wherein the molar ratio of the methacrylate monomer to the “semi-fluorinated” alternating copolymer(AB)ₙ macroinitiator is 30-500:1-3.

10. A block copolymer with a main-chain “semi-fluorinated” alternating copolymer of Formula (2) or Formula (4) prepared by the photopolymerization method according to claim 1.
